(19) United States
(12) Patent Application Publication
(10) Pub. No.: US 2005/0279828 A1
(43) Pub. Date: Dec. 22, 2005

(54) Optical motor-vehicle card

(75) Inventor: W. Jack Harper, Evergreen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BSI2000, Inc., Lakewood, CO (US)

(21) Appl. No.: 11/145,522

(22) Filed: Jun. 3, 2005

Related U.S. Application Data
(60) Provisional application No. 60/577,076, filed on Jun. 4, 2004.

(51) Int. Cl. G06K 5/00; G06K 19/00

(52) U.S. Cl. 235/380; 235/487

(57) ABSTRACT

An optical motor-vehicle card is provided as a laminated card having a pattern of burn holes that encode information according to a set of fields. One field is an identification field having optically encoded information identifying an authorized holder of the optical motor-vehicle card. Another field is a driving-status field having optically encoded information summarizing an authorized driving status of the authorized holder.

### CROSS-REFERENCES TO RELATED APPLICATIONS

This application is a nonprovisional of, and claims the benefit of U.S. Appl. No. 60/577,076 entitled “OPTICAL MOTOR-VEHICLE CARD,” the filing date of Jun. 4, 2004 by W. Jack Harper, the entire disclosure of which is incorporated herein by reference for all purposes.

### BACKGROUND OF THE INVENTION

This application relates generally to optical cards. More specifically, this application relates to the use of optical cards for motor-vehicle applications.

Operators of motor vehicles are typically subject to a number of varied requirements for the operation of the vehicle to be considered lawful. The operator generally must be licensed by a government authority to operate the vehicle and may have restrictions imposed on that operation by virtue of experience levels or physical limitations. The operator is also generally required to be insured for at least some specified level, usually to cover liability for injuries that may be caused to a third party by the operator. In addition, the vehicle itself usually must be properly registered, a process that requires the payment of taxes to a government authority. Proof of compliance with all of these, and other, requirements needs to be available to the operator so that he can establish compliance in response to a request from a law-enforcement officer, such as in connection with a traffic stop. Still other information may be desired by the law-enforcement officer in determining how to handle a traffic stop, such as a driving history specifying past infractions by the operator, particularly if the traffic stop was made in response to an observed driving infraction.

Traditionally, these various pieces of information have been recorded in different places, some on documents that are intended to be carried by the operator, some on documents that are intended to be kept in the motor vehicle, and some in central databases that require the field law-enforcement officer to communicate with a central office to access the information. For instance, a paper driver's license may be carried by the operator on his person, as may be registration documents; a card providing proof of adequate insurance may be kept in the motor vehicle; and the driving-history information may be maintained in the central database. The scattered nature of the information as it is maintained on multiple documents and in difficult-to-access databases causes inconvenience both for the vehicle operator and for the law-enforcement officer. The operator may find it difficult to locate the various pieces of information requested during a traffic stop, particularly since some of the documents are accessed only infrequently and since the operator is likely to be nervous responding to the officer's demands. The effectiveness of the officer's review of compliance with the various requirements is thus also affected, and the need to communicate with a central office to access driving-history information increases both the inefficiency of the process and the potential for errors.

There is accordingly a general need in the art for a more effective mechanism to make information related to operation of motor vehicles accessible.

### BRIEF SUMMARY OF THE INVENTION

Embodiments of the invention provide an optical motor-vehicle card that allows integration of a variety of different types of information in a compact format. In one set of embodiments, an optical motor-vehicle card comprises a laminated card having a pattern of burn holes that encode information according to a set of fields. One field is an identification field having optically encoded information identifying an authorized holder of the optical motor-vehicle card. Another field is a driving-status field having optically encoded information summarizing an authorized driving status of the authorized holder.

The identification field may comprise optically encoded information identifying a physical feature of the authorized holder, such as a sex of the authorized holder, a height of the authorized holder, a hair color of the authorized holder, an eye color of the authorized holder, and the like. The information identifying a physical feature may take the form of an optically encoded photograph of the authorized holder or an optically encoded fingerprint in different embodiments. The identification field may also comprise an optically encoded signature of the authorized holder in some embodiments. The driving status field may comprise optically encoded information identifying a license classification of the authorized holder, may comprise optically encoded information identifying driving restrictions placed on the authorized holder, and/or may comprise optically encoded information identifying a history of driving infractions assessed against the authorized holder.

The set of fields may also comprise an insurance field having optically encoded information identifying driving insurance carried by the authorized holder in some embodiments. In some instances, the set of fields may comprise a voting-registration field having optically encoded information identifying a status of the authorized holder as eligible to vote in at least one identified political territory. In other instances, the set of fields may comprise an organ-donation field having optically encoded information identifying directions of the authorized holder for organ donation. In one embodiment, the set of fields further comprises registration-information field having optically encoded information identifying a vehicle registered with a vehicle-registration authority, and an owner of the vehicle. The information identifying the vehicle may comprise a vehicle identification number assigned to the vehicle in one embodiment. In some instances, the owner of the vehicle is the authorized holder of the optical motor-vehicle card.

In another set of embodiments, an optical motor-vehicle card comprises a laminated card having a pattern of burn holes that encode information according to a set of fields. One set of fields comprises an identification field having optically encoded information identifying an authorized holder of the optical motor-vehicle card. Another set of fields comprises a registration-information field having optically encoded information identifying a vehicle registered with a vehicle-registration authority, and an owner of the vehicle. The vehicle may be identified with a vehicle identification number in some embodiments.

In a further set of embodiments, a method is provided for aiding a law-enforcement officer in evaluating an operator of a motor vehicle. An optical motor-vehicle card presented by the operator in response to a request from the law-enforcement officer is received with an optical-card processing unit. The optical motor-vehicle card includes an identification field having optically encoded information identifying an authorized holder of the optical motor-vehicle card and a driving-status field having optically encoded information summarizing an authorized driving status of the authorized holder. The optically encoded information identifying the authorized holder is decoded from the optical motor-vehicle card with the optical-card processing unit. A display is generated from the decoded information identifying the authorized holder for presentation to the law-enforcement officer to allow the law-enforcement officer to confirm the operator is the authorized holder. The optically encoded information summarizing the authorized driving status of the authorized holder is decoded. The decoded information summarizing the authorized driving status is displayed to the law-enforcement officer as an information aid to the law-enforcement officer in determining a course of action. In various embodiments, the optical motor-vehicle card may have additional optically encoded information such as that described above, with the method further comprising decoding and displaying that information to the law-enforcement officer as part of the information aid.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIGS. 1A-1C are illustrations of different embodiments of optical motor-vehicle cards;

FIGS. 2A-2C are schematic illustrations of different embodiments of architectures that may be used with the optical motor-vehicle cards of FIGS. 1A-1C;

FIG. 3 is a diagram providing an exemplary data structure for information maintained on an optical motor-vehicle card; and

FIGS. 4A-4E are flow diagrams illustrating different methods for using the optical motor-vehicle cards of FIGS. 1A-1C.

### DETAILED DESCRIPTION OF THE INVENTION

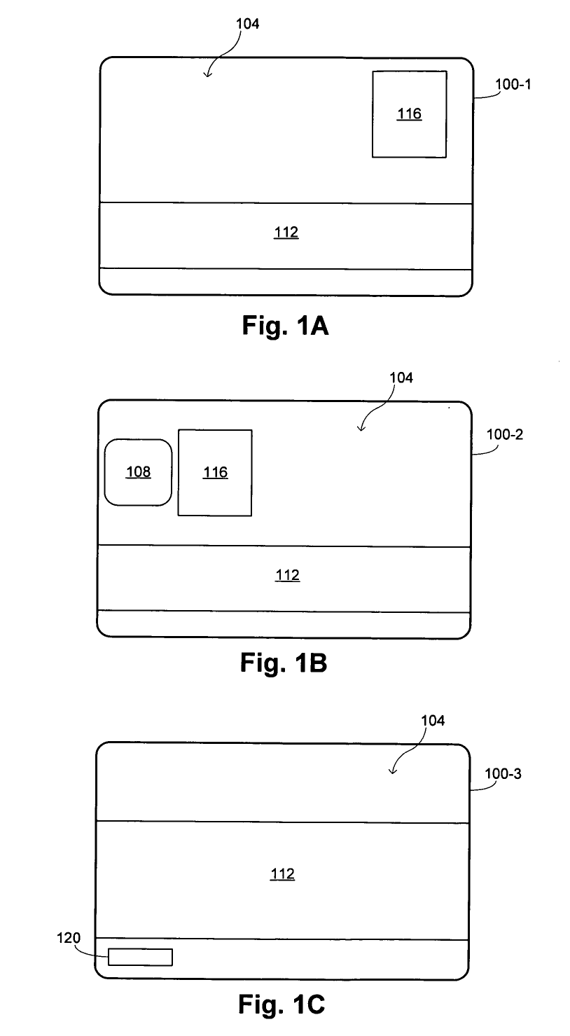

Embodiments of the invention provide methods and systems that allow information related to motor-vehicle operation to be consolidated on optical cards. Such embodiments may function well with a variety of optical-card designs, some of which are illustrated in FIGS. 1A-1C. Such optical cards may be of the specific type described in U.S. Pat. No. 5,979,772, entitled “OPTICAL CARD” by Jiro Takei et al., the entire disclosure of which is incorporated herein by reference for all purposes, but more generally include any card that uses optical storage techniques. Such optical cards are typically capable of storing very large amounts of data in comparison with magnetic-stripe or smart cards. For example, a typical optical card may compactly store up to 4 Mbyte of data, equivalent to about 1500 pages of typewritten information. As such, optical cards hold on the order of 1000 times the amount of information as a typical smart card. Unlike smart cards, optical cards are also impervious to electromagnetic fields, including static electricity, and they are not damaged by normal bending and flexing.

These properties of optical cards, particularly their large storage capacity, makes it possible for complete motor-vehicle information records to be stored, including identification information, driving-status information, insurance information, and vehicle registration information, in addition to additional information that is often associated with a driver's license such as voting-registration information and organ-donation information, among others. All such information is described collectively herein as “motor-vehicle information.” For example, a single optical card may store fingerprint biometrics for all ten fingers, iris biometrics for both eyes, hand-geometry specifications for both hands, and a high-resolution color photograph of a cardholder while still using far less than 1% of its capacity. The large storage capacity also allows information for essentially every use that involves the card to be written to the card and thereby provide a permanent detailed audit trail of the card's use.

Many optical cards use a technology similar to the one used for compact discs (“CDs”) or for CD ROMs. For example, a panel of gold-colored laser-sensitive material may be laminated on the card and used to store the information. The material comprises several layers that react when a laser light is directed at them. The laser burns a small hole, about 2 μm in diameter, in the material; the hole can be sensed by a low-power laser during a read cycle. The presence or absence of the burn spot defines a binary state that is used to encode data. In some embodiments, the data can be encoded in a linear x-y format described in detail in the ISO/IEC 11693 and 11694 standards, the entire contents of which are incorporated herein by reference for all purposes.

FIG. 1A provides a diagram that illustrates a structure for an optical motor-vehicle card in one embodiment. The card 100-1 includes a cardholder photograph 116, an optical storage area 112, and a printed area 104 on one side of the card. The other side of the card could include other features, such as a bar code(s) or other optically recognizable code, a signature block, a magnetic stripe, counterfeiting safeguards, and the like. The printed area 104 could include any type of information, such as information identifying the cardholder so that, in combination with the photograph 116, it acts as a useful aid in authenticating a cardholder's identity. The optical storage area 112 holds digitized information, and may comprise a plurality of individual sections that may be designated individually by an addressing system.

The information on optical cards is generally visible to readers, and may in some instances be encrypted to prevent unauthorized access. A description of encryption and other security techniques that may be used with the optical cards is provided in copending, commonly assigned U.S. Prov. Pat. Appl. No. ______, entitled “CRYPTOGRAPHICALLY SECURED TRANSACTIONS WITH OPTICAL CARDS,” filed Feb. 10, 2004 by Jack Harper (Attorney Docket No. 040172-000800US), the entire disclosure of which is incorporated herein by reference for all purposes. Information on the optical banking card 100 may also sometimes be authenticated. Authenticated information can be verified as being unmodified by any number of parties in a trust chain. By using certificates, the authenticity of the stored information can be confirmed by a number of parties. Various techniques using a variety of different algorithms known to those of skill in the art may be used to confirm authenticity. In some cases, the authenticity of an optical motor-vehicle card may be confirmed from a wide-area network, but in other cases authenticity can be confirmed without contacting other parties.

Another embodiment of an optical motor-vehicle card 100-2 is illustrated in FIG. 1B. This embodiment adds electronics 108 to the optical motor-vehicle card 100-2 to provide smart-card capabilities. The electronics 108 may be interfaced with contacts on the surface of the card 100-2. The electronics could include a microprocessor, nonvolatile memory, volatile memory, a cryptographic processor, a random-number generator, and/or any other electronic circuits. Unlike the optical storage area 112, information stored in the electronics 108 is not discernible without destroying the card 100-2. Electronic security measures could be used to protect reading information stored in the electronics 108.

A further embodiment of an optical motor-vehicle card 100-3 is shown in FIG. 1C. To illustrate that different embodiments may accommodate different sizes of optical storage areas, this embodiment uses a larger optical storage area 112 than the embodiments of FIG. 1A or 1B. In addition, a radio-frequency identification (“RFID”) tag 120 that can be read by proximity readers may be included.

The optical motor-vehicle cards illustrated in FIGS. 1A-1C may be used in a variety of different network structures, some of which do not require large, complex support systems. For example, in some network structures, a plurality of optical-card processing units are interconnected solely by optical cards. In such cases, motor-vehicle information is stored only on the optical cards carried by cardholders, rather than being stored in any central or local database. Software and other informational updates to the optical-card processing units may be communicated with optical cards containing information for those purposes. A detailed description of a optical-card processing unit that may be used in embodiments of the invention is provided in copending, commonly assigned U.S. patent application Ser. No. 09/454,717, entitled “OPTICAL CARD BASED SYSTEM FOR INDVIDUALIZED TRACKING AND RECORD KEEPING,” filed Dec. 6, 1999 by Jack Harper, the entire disclosure of which is incorporated herein by reference for all purposes. Generally, the optical-card processing unit may include a card slot adapted to accept an optical card so that data may be read from or written to the optical card, a display screen for displaying data about the optical card or transaction being executed, and a printer for generating hard copy.

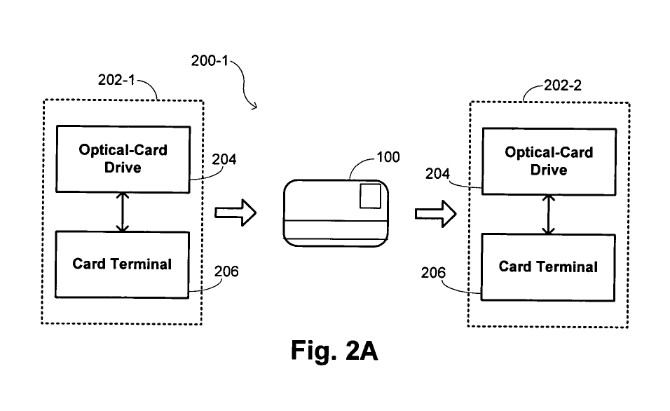

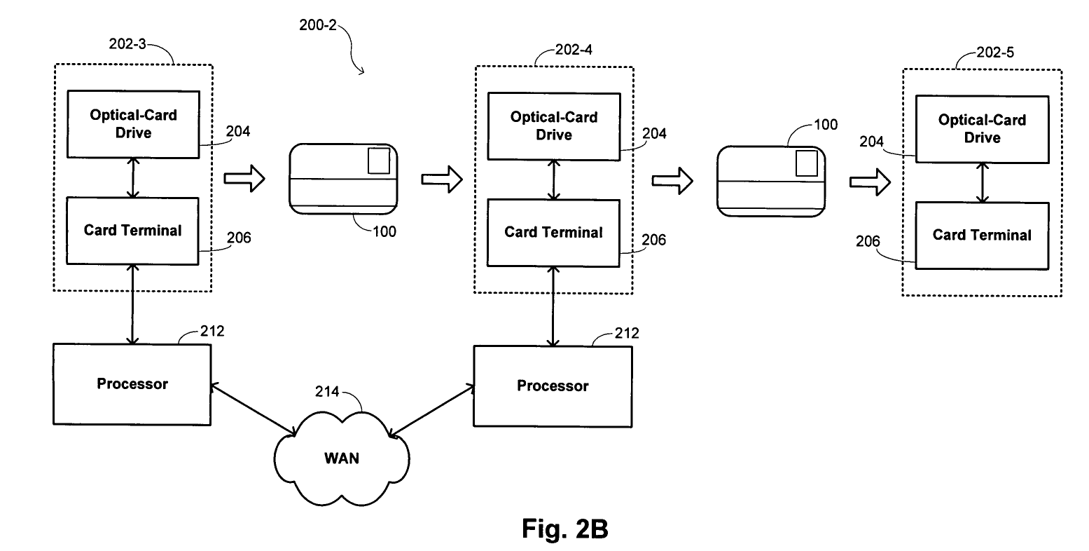

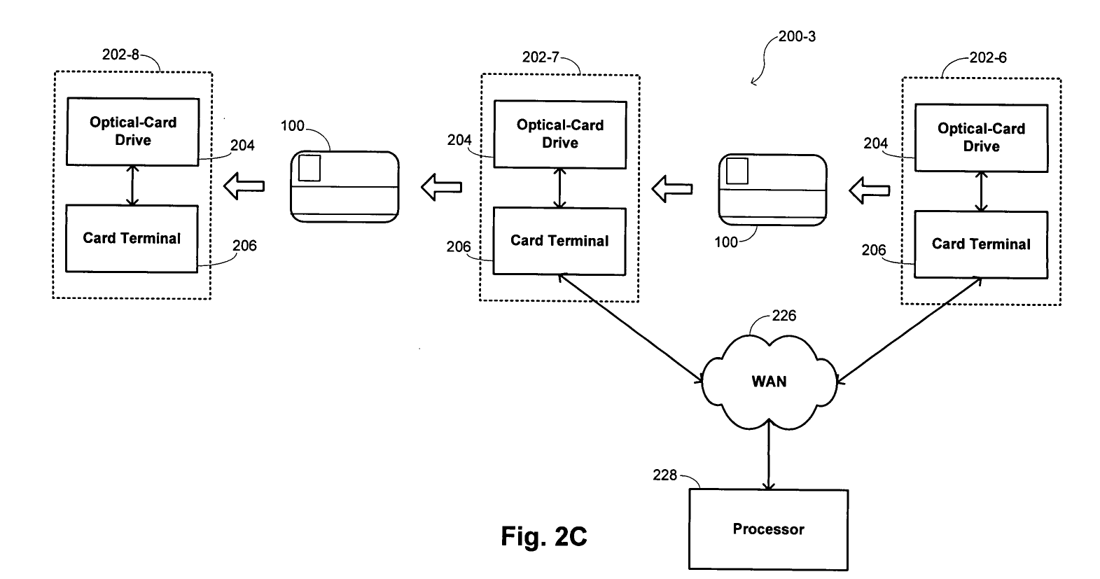

One network structure 200-1 that may be used to interconnect motor-vehicle information with the optical motor-vehicle cards is illustrated in FIG. 2A. In this figure, each optical-card processing unit 202 is shown to comprise an optical-card drive 204 and a card terminal 206. These components may be provided as separate components of the optical-card processing unit 202 or may be integrated in different embodiments. The optical-card drive 204 is configured for reading from and writing to optical cards, while the card terminal 206 comprises a computational device used in implementing specific functionality, some examples of which are provided below. While the drawing in FIG. 2A shows two optical-card processing units 202 for illustrative purposes, there will generally be a much larger number of optical-card processing units 202 distributed within the system. For instance, some optical-card processing units 202 may be located on police cruisers or other law-enforcement vehicles, some optical-card processing units 202 may be provided as part of self-service kiosks at motor-vehicle service locations, some optical-card processing units 202 may be provided at customer-service stations at motor-vehicle service locations, some optical-card processing units 202 may be provided in law-enforcement locations such as police stations, and the like. Each time the optical card 100 is used at an optical-card processing unit 202, information about the usage and updates to the information maintained on the card may be written to the card. This information is then accessible by a subsequent optical-card processing unit 202 to which the card may be presented later.

In some instances, such as shown in FIG. 2B, some of the optical-card processing units 202 may additionally be interconnected with an electronic or similar network. For example, optical-card processing units 202-3 and 202-4 have their respective card terminals 206 provided in communication with processors 212, which are themselves interconnected through a non-optical network such as a wide-area network (“WAN”) 214. Because each of these optical-card processing units 202 is interfaced with a processor 212, they may be considered to function as “smart” processing units, in contrast to those processing units that are not individually interfaced with a processor. Each of the processors 212 may additionally be coupled with one or more databases that maintain information related to governance of motor vehicles, such as current licensing requirements, insurance requirements, registration requirements, and the like. The interconnectivity provided between the optical-card processing units 202 in this way allows-communications among the optical-card processing units 202 to occur without requiring distribution of the optical motor-vehicle cards 100 themselves, allowing further mechanisms for sharing information among the optical-card processing units 202. This may be valuable for optical-card processing units 202 that are located in fixed locations like at law-enforcement locations or at motor-vehicle service locations.

Other optical-card processing units 202 within the network structure 200-2 may be accessible only through exchange of optical cards 100, illustrated by optical-card processing unit 202-5 in FIG. 2B. Within this network structure, such a processing unit 202-5 might correspond to a mobile optical-card processing unit 202-5, such as one that is mounted within a police cruiser for accessing information from optical motor-vehicle cards in the field. Irrespective of whether the optical-card processing units 202 are interconnected solely through the exchange of optical cards 100 or have some supplementary WAN interconnection 214, the information maintained on the optical cards 100 is current and is considered to be the authoritative source of such information. Thus, the same information is available to a party using the optical motor-vehicle card 100 irrespective of whether the optical-card processing unit 202 used to access the information is connected with the supplementary WAN interconnection 214.

FIG. 2C illustrates a network structure 200-3 that is similar to that shown in FIG. 2B, except that the card terminals 206 of some of the optical-card processing units 202 are interconnected directly with a WAN 226 that interfaces with a common processor 228. In such embodiments, those optical-card processing units 202 that are connected with the supplementary network still act as “dumb” processing units since they are not individually interfaced with a processor. In the specific example shown in FIG. 2C, optical-card processing units 202-6 and 202-7 have an interconnection with the WAN 226 and may be suitable as fixed-location units while optical-card processing unit 202-8, which is interconnected only through exchange of optical cards, may be suitable as a mobile unit.

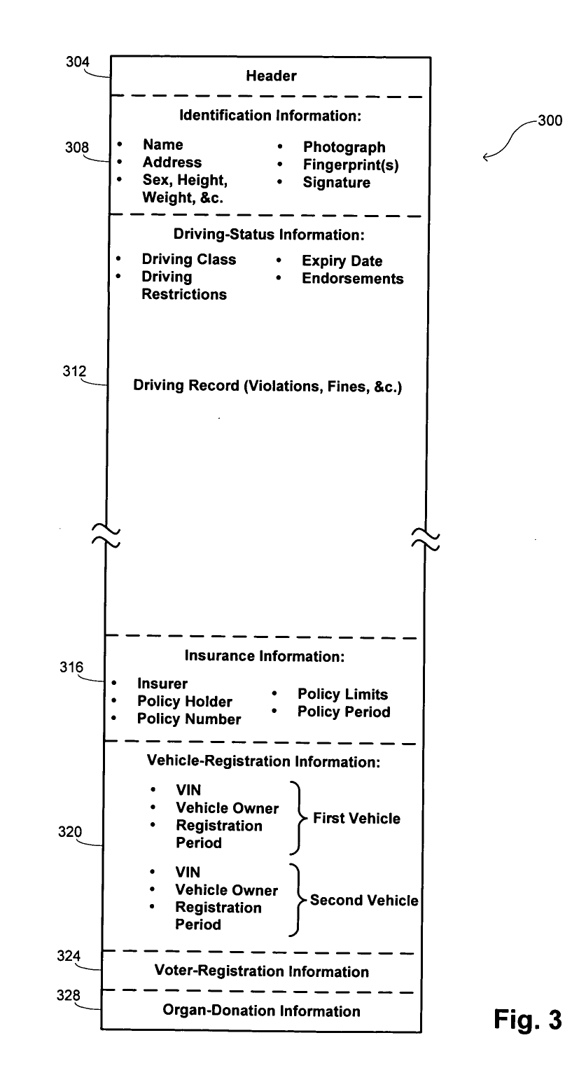

The optical motor-vehicle cards 100 used by any of the architectures described in connection with FIGS. 2A-2C, or with any similar architectures, may use any of a variety of different data structures to store information used in motor-vehicle applications. One such data structure 300 is shown explicitly in FIG. 3 for illustrative purposes. In this embodiment, the optical motor-vehicle card data structure 300 comprises a header 304, fields 308 for providing identification information, fields 312 for maintaining driving-status information, fields 316 for maintaining insurance information, fields 320 for maintaining vehicle-registration information, and additionally fields for maintaining supplementary information incidental to motor-vehicle applications, such as a field 324 for maintaining voter-registration information and a field 328 for maintaining organ-donation information. The header identifies the data structure 300 and includes a description of the data structure, specifying such characteristics as size, encryption format, certificate format, version information, and the like. This header information may thus be used by on optical-card drive in determining how to extract the information encoded in the information fields.

The identification fields 304 include optically encoded representations of a variety of different types of identification information. Some such information is descriptive, allowing a party extracting the information to perform a comparison of it with corresponding characteristics of the holder of the optical motor-vehicle card to confirm that the holder is the person identified by the card. For example, such descriptive information may include a photograph of an authorized holder, one or more fingerprints of the authorized holder, a textual description of the holder specifying such physical characteristics as sex, height, weight, the presence of scars, and the like. Such examples allow a comparison of physical characteristics of the holder, but other types of comparison may be enabled by the storage of other types of descriptive information on the card. For instance, storage of a signature allows a limited handwriting comparison to be performed. Other types of description information may include personal information unlikely to be known by other than authorized holder's such as a mother's maiden name, and the like. In addition to the descriptive information, the identification fields 308 may comprise designation information that specifies who the authorized holder is. Such designation information may comprise the name of the authorized holder, the address of the authorized holder, and the like.

The driving-status information fields 312 includes an overview of the status of the authorized holder as a licensed driver and includes a detailed specification of the authorized holder's driving record. The status overview may specify such information as the expiry date of the license provided to the authorized holder, the class of such a license, and any driving restrictions placed on the authorized holder as part of the license. Examples of license classes include a variety of commercial license classes that allow the authorized holder to drive for profit and specify limits on the size and/or weight of vehicles that may be driven. The license classes may also include various noncommercial license classes that also specify limits on size and/or weight of vehicles, and may allow or restrict the authorized holder from operating specific motor vehicles such as motorcycles, farm vehicles, snowmobiles, and the like. Some license specifications may indicate that the license is limited to learner functions, imposing further restrictions on the time of day, type of roadway, etc., and perhaps imposing stricter limits on blood-alcohol levels even where the authorized holder is of legal drinking age. Driving restrictions that may be specified may account for a variety of different physical and/or cognitive limitations that may be specific to the authorized holder. For example, such driving restrictions may require the use of corrective devices such as corrective lenses or hearing aids, or may require that the vehicle being driven have certain specified modifications, such as a hand control, pedal extension, left-foot accelerator, power steering, automatic transmission, probationary interlock devices, an outside rearview mirror, a seat cushion, and the like. Some driving restrictions may prohibit the transport of any passengers or may modify the conditions of certain driving classes by imposing additional limitations on vehicle size and/or weight, type of roadway, time of day, and the like. In some instances, endorsements may be specified as part of the driving-status information that records an authorization for the authorized holder to operate a motor-vehicle beyond the normal scope of the license class, such as by authorizing the transport of hazardous materials, the transport of large volumes of liquid or gaseous material, the transport of large numbers of passengers, authorizing the operation of multiple-trailer vehicles, and the like.

The detailed driving record that is comprised by the driving-status information fields 312 may include a record of every vehicle-related crime or offense committed by the authorized holder, such as a record of all violations of traffic and parking regulations. Such a detailed record may specify such particulars as the date of the infraction, the level of any punishment imposed, whether by imprisonment, fine, or otherwise, and the like. In some instances, the driving record may include particulars of other types of infractions related only peripherally to driving, such as public drunkenness, automobile theft, and the like. In one embodiment, the driving record comprises a complete history of all criminal convictions of the authorized holder whether or not specifically related to driving. Which information to be included, and the level of detail describing the particulars of infractions, may reflect a legislative judgment of what information may be useful to law-enforcement officers in discretionary aspects of enforcing motor-vehicle regulations.

The insurance-information fields 316 include optically encoded representations that specify what insurance coverage is maintained by the authorized holder of the card 300. This information generally identifies the insurance provider, such as by name, address, telephone number, as well as particulars about the nature of the insurance coverage provided. For example, such particulars may include the policy identification number, the name of the policy holder, limits that are placed on recovery amounts, the effective period of the policy, and the like. The information is generally intended to be sufficient to confirm that the insurance coverage meets the minimum levels required in a particular jurisdiction. In some instances, the insurance-information fields 316 may be limited to providing information directly relevant to those requirements, but in other embodiments the insurance information may be more complete. For example, in one embodiment, information regarding all insurance coverage maintained by the authorized holder may be specified, including such insurance homeowner's insurance, umbrella insurance, professional malpractice insurance, and other types of insurance that may not directly be involved in motor-vehicle incidents. In this way, the optical motor-vehicle card 100 may act as a convenient centralized repository for all insurance information for the authorized holder.

The vehicle-registration fields 320 include optically encoded representations that define the registration status of vehicles that may be operated on a regular basis by the authorized holder. While the authorized holder may or may not be the registered owner of any such vehicles, it is convenient for the registration information for those vehicles that he regularly operates to be easily accessible. In some instances, a licensed motor-vehicle operator may not operate any specific vehicles regularly, so that no information is included in the vehicle-registration fields, but more usually the authorized holder will operate one or more motor vehicles on a regular basis. For each such vehicle, the registration information may include an identification of the vehicle, an identification of the owner of the vehicle, and an identification of the period over registration is valid. Identification of the vehicle may be provided with the Vehicle Identification Number (“VIN”), which is used in many countries to provide a unique identification of motor vehicles in accordance with ISO Standard 3779, as well as providing such particulars as the year, make, and color of the vehicle, as well as the alphanumeric string printed on any license plate assigned to the vehicle.

There is a wide scope of information types that may be included in the supplementary information fields depending on their specific intended utility. For instance, in the case of a voter-registration information field 324, the information may indicate those jurisdictions in which the authorized holder has satisfied voter-registration requirements. In the case of an organ-donation information field 328, the information may indicate whether an anatomical gift is to be made by the authorized holder, effective on the authorized holder's death, and what the nature of that gift is by specifying specific organs or tissues to be donated, requesting or refusing donation of the authorized holder's body to a medical school, and the like. The specification of organ-donation wishes may be considered to be an example of a broader class of information that may be included specifying treatment wishes generally, so that this field may include “do-not-resuscitate” and other advance directives of the type that may be provided in a so-called “living will.”

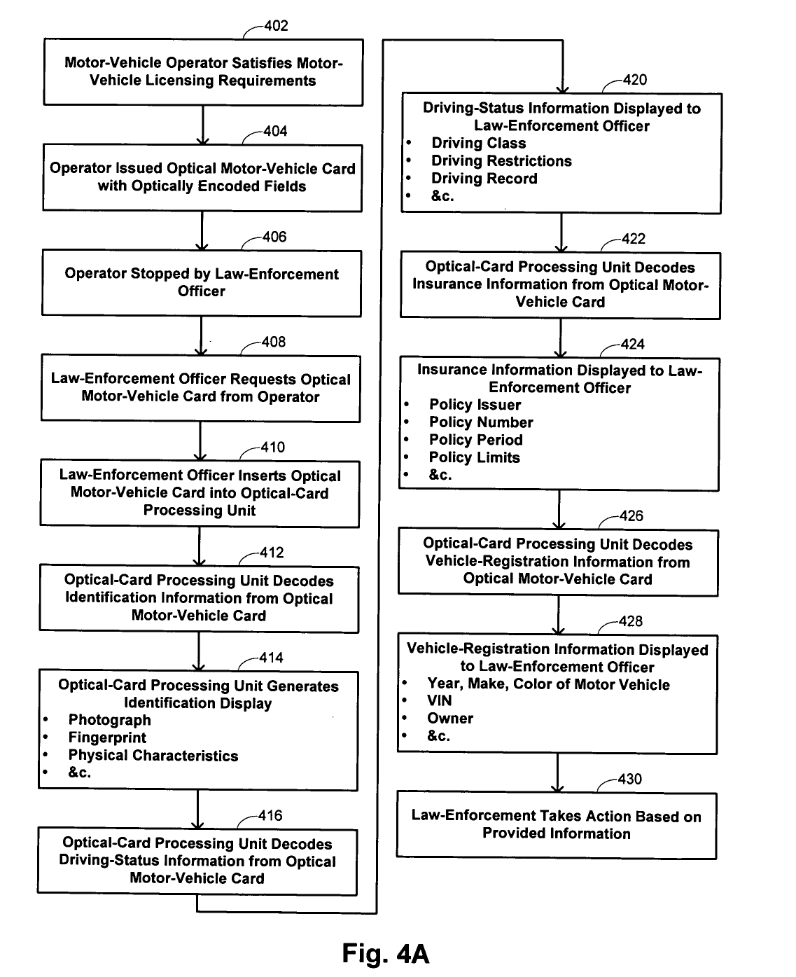

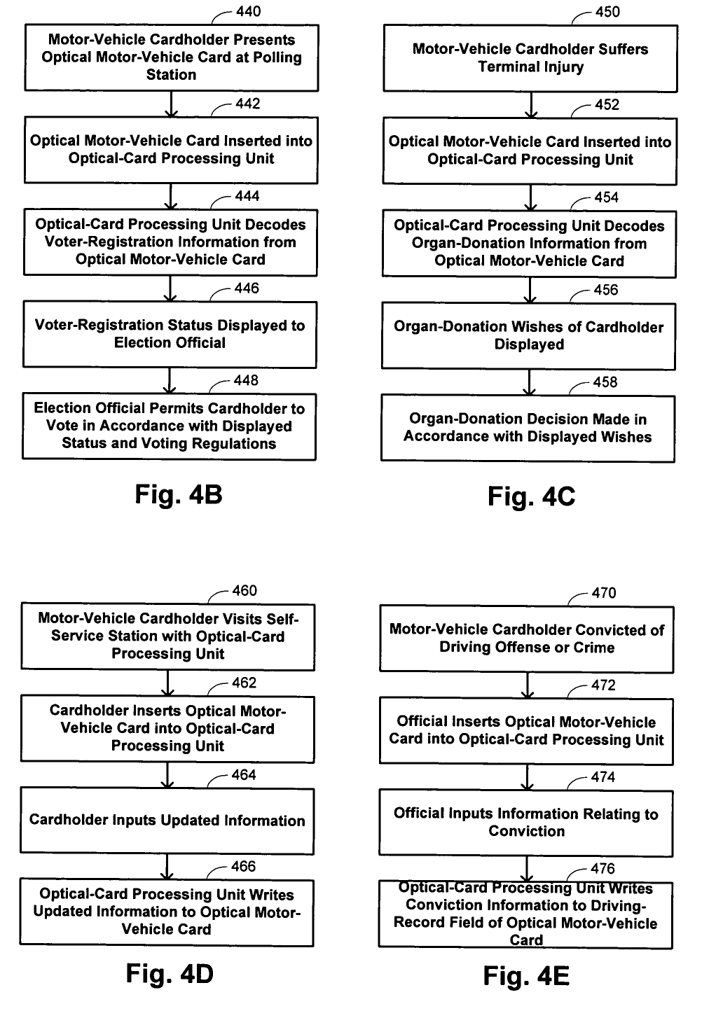

The collection of information comprised by the optical motor-vehicle card 100 thus provides a convenient collection of diverse pieces of information in a compact format. There are a variety of ways in which such a compact arrangement enables the information to be used effectively, some of which are described in connection with FIGS. 4A-4E.

FIG. 4A generally describes a principal function of the optical motor-vehicle card 100 in one embodiment as providing documentation to aid a law-enforcement officer in evaluating an operator of a motor vehicle. Such documentation originates, as indicated at block 402, by a motor-vehicle operator satisfying certain licensing requirements for operating a motor vehicle. Such requirements typically involve passing written and practical tests showing a knowledge of applicable regulations and an ability to operate the vehicle competently. The operator is issued an optical motor-vehicle card 100 having some or all of the optically encoded fields described in connection with FIG. 3 at block 404. If the operator is stopped by a law-enforcement officer at block 406 and is asked by the law-enforcement officer at block 408 to provide documentation permitting the operator to operate the vehicle, the operator may present the issued optical motor-vehicle card to the officer.

The officer may access the information from the presented optical motor-vehicle card by inserting the card into an optical-card drive at block 410, usually a drive that is comprised by an optical-card processing unit in the officer's own vehicle as described above in connection with FIGS. 2A-2C. The optical-card drive decodes the identification information from the optical motor-vehicle card at block 412 to generate a display of identification information at block 414. Such a display may depend on the specific type of identification information stored on the optical motor-vehicle card, but may include such presentation of a photograph, presentation of a fingerprint, a list of physical characteristics like those described above, and the like. All of this information may be used by the law-enforcement officer to confirm that the person who presented the optical motor-vehicle card is the authorized holder identified by the identification information on the card.

In addition, as indicated at block 416, the optical-card drive may decode the driving-status information from the optical motor-vehicle card so that the decoded information may be displayed to the law-enforcement officer at block 420. This information may provide the law-enforcement officer with an indication of the driving class, driving restrictions, and the like of the authorized holder so that the officer may determine whether the person was operating the vehicle in accordance with his authorization. The availability of driving-record information may be useful in informing the discretionary authority that the officer has, allowing the officer to treat a particular offense as one more in a pattern of offenses or as an apparently isolated incident.

At block 422, the insurance information is decoded from the optical motor-vehicle card so that the decoded insurance information may be displayed to the law-enforcement officer at block 424. Information specifying the nature of insurance coverage in terms of the policy period, policy limit, and the like, may be used by the officer to confirm compliance with applicable insurance requirements.

The optical-card drive may also decode registration information at block 426 so that such vehicle-registration information may be displayed for the officer's examination at block 428. Descriptive information of the vehicle allows the officer to confirm that the vehicle being operated is one of those whose valid registration status is confirmed by the information on the optical motor-vehicle card.

Block 430 of FIG. 4A thus indicates generally that the law-enforcement officer takes some action based on the information extracted from the optical motor-vehicle card. The specific action that is taken will depend on the exercise of judgment by the officer in accordance with his training, as informed by the various collected pieces of information included on the optical motor-vehicle card. The ability to present a single card that includes up-to-date information of disparate types simplifies the interaction between the cardholder and the officer, in part because it is considerably easier for the cardholder to access the information and make it available to the officer. In addition, the information read from the card is more informative than information that would otherwise be provided as documentary evidence by the vehicle operator—for example, the officer may be provided with a complete and current driving record in some embodiments so that he need not attempt to contact a central authority for that information, further increasing the reliability and efficiency of the officer's assessment.

FIGS. 4B and 4C provide flow diagrams that illustrate examples of other uses for the optical motor-vehicle card, in particular examples that make use of the supplementary information fields. FIG. 4B provides a flow diagram for using the optical motor-vehicle card to establish eligibility to vote. The cardholder presents the optical motor-vehicle card at a polling station equipped with an optical-card processing unit at block 440. The card is inserted into an optical-card drive comprised by the processing unit at block 442 so that information from the voter-registration field may be decoded at block 444 and displayed to the election official at block 446. The election official uses the information, which generally provides an indication that the authorized holder of the card is or is not eligible to vote at that polling station, to permit the authorized holder to vote at block 448 in accordance with applicable voting regulations. In making that determination, the election official will usually also require some proof that the person presenting the motor-vehicle optical card is the person authorized to vote in the voter-registration field. Such proof may be drawn from separate identification credentials presented by the cardholder or may be drawn from the identification-field information on the optical motor-vehicle card itself.

FIG. 4C provides a flow diagram for using the optical motor-vehicle card to determine how to respond to a terminal injury suffered by the cardholder at block 450. The cardholder may be transported to a hospital equipped with an optical-card processing unit so that the optical motor-vehicle card is inserted into an optical-card drive at block 452. The optical-card drive decodes the organ-donation information from the optical motor-vehicle card at block 454 and displays the wishes of the cardholder at block 456, from which an organ-donation decision may be made at block 458. The same method illustrated in FIG. 4C may be used in instances where other types of advance directives are provided in fields of the optical motor-vehicle card as described above in connection with FIG. 3.

The supplementary uses of the optical motor-vehicle cards illustrated in FIGS. 4B and 4C are merely examples of a wide variety of uses that are enabled by such cards. For example, the cards may be used generally as identification cards in a variety of environments that include optical-card processing units, may be used as age-identification cards in environments where age restrictions apply, and the like. In addition to the identification fields having such wide applicability, other fields may also have additional uses. For instance, the insurance information fields may provide a simple mechanism for the exchange of insurance information at the scene of an accident, particularly if a law-enforcement officer having an optical-card processing unit is at the scene.

There are a variety of ways in which information on the optical motor-vehicle cards may be updated. In some instances, updates of certain types of information may be initiated by the authorized holder of the card while updates of other types of information may be initiated only by an authorized official. For example, it may be possible to update information such as address and the like by the cardholder, while information that is controlled by a government authority such as driving history may require initiation by an authorized official to be updated. FIG. 4D provides a flow diagram illustrating how the authorized holder may update information in one embodiment by using a self-service station. Such a self-service station may be a kiosk located at motor-vehicle office or could in some instances be any self-service station having an optical-card processing unit, even those intended for other purposes. The cardholder visits the self-service station at block 460 and inserts the optical motor-vehicle card into the optical-card drive at block 462. Updated information is input by the cardholder at block 464 and the optical-card drive writes the updated information to the optical motor-vehicle card at block 466.

One example of information that requires updating only on the authority of an authorized official is the driving history information, an example that is illustrated with the flow diagram of FIG. 4E. After a cardholder is convicted of a driving offense or crime at block 470, the authorized official inserts the optical motor-vehicle card into the optical-card drive at block 472, allowing the official to input information relating to the conviction at block 476. The conviction information is then written to the driving-record field of the card at block 476.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. An optical motor-vehicle card comprising a laminated card having a pattern of burn holes that encode information according to a set of fields, the set of fields comprising:
an identification field having optically encoded information identifying an authorized holder of the optical motor-vehicle card; and
a driving-status field having optically encoded information summarizing an authorized driving status of the authorized holder.

2. The optical motor-vehicle card recited in claim 1 wherein the identification field comprises optically encoded information identifying a physical feature of the authorized holder.

3. The optical motor-vehicle card recited in claim 2 wherein the optically encoded information identifying the physical feature of the authorized holder identifies at least one of a sex of the authorized holder, a height of the authorized holder, a hair color of the authorized holder, and an eye color of the authorized holder.

4. The optical motor-vehicle card recited in claim 2 wherein the optically encoded information identifying the physical feature of the authorized holder comprises an optically encoded photograph of the authorized holder.

5. The optical motor-vehicle card recited in claim 2 wherein the optically encoded information identifying the physical feature of the authorized holder comprises an optically encoded fingerprint of the authorized holder.

6. The optical motor-vehicle card recited in claim 1 wherein the identification field comprises an optically encoded signature of the authorized holder.

7. The optical motor-vehicle card recited in claim 1 wherein the driving-status field comprises optically encoded information identifying a license classification of the authorized holder.

8. The optical motor-vehicle card recited in claim 1 wherein the driving-status field comprises optically encoded information identifying driving restrictions placed on the authorized holder.

9. The optical motor-vehicle card recited in claim 1 wherein the driving-status field comprises optically encoded information identifying a history of driving infractions assessed against the authorized holder.

10. The optical motor-vehicle card recited in claim 1 wherein the set of fields further comprises an insurance field having optically encoded information identifying driving insurance carried by the authorized holder.

11. The optical motor-vehicle card recited in claim 1 wherein the set of fields further comprises a voting-registration field having optically encoded information identifying a status of the authorized holder as eligible to vote in at least one identified political territory.

12. The optical motor-vehicle card recited in claim 1 wherein the set of fields further comprises an organ-donation field having optically encoded information identifying directions of the authorized holder for organ donation.

13. The optical motor-vehicle card recited in claim 1 wherein the set of fields further comprises a registration-information field having optically encoded information identifying:
a vehicle registered with a vehicle-registration authority; and
an owner of the vehicle.

14. The optical motor-vehicle card recited in claim 13 wherein the optically encoded information identifying the vehicle comprises a vehicle identification number assigned to the vehicle.

15. The optical motor-vehicle card recited in claim 13 wherein the owner is the authorized holder.

16. An optical motor-vehicle card comprising a laminated card having a pattern of burn holes that encode information according to a set of fields, the set of fields comprising:
an identification field having optically encoded information identifying an authorized holder of the optical motor-vehicle card; and
a registration-information field having optically encoded information identifying:
a vehicle registered with a vehicle-registration authority; and
an owner of the vehicle.

17. The optical motor-vehicle card recited in claim 16 wherein the optically encoded information identifying the vehicle comprises a vehicle identification number assigned to the vehicle.

18. A method for aiding a law-enforcement officer in evaluating an operator of a motor vehicle, the method comprising:
receiving, with an optical-card processing unit, an optical motor-vehicle card presented by the operator in response to a request from the law-enforcement officer, the optical motor-vehicle card including an identification field having optically encoded information identifying an authorized holder of the optical motor-vehicle card and a driving-status field having optically encoded information summarizing an authorized driving status of the authorized holder;
decoding, with the optical-card processing unit, the optically encoded information identifying the authorized holder from the optical motor-vehicle card;
generating, from the decoded information identifying the authorized holder, a display for presentation to the law-enforcement officer to allow the law-enforcement officer to confirm the operator is the authorized holder;
decoding, with the optical-card processing unit, the optically encoded information summarizing the authorized driving status of the authorized holder; and
displaying the decoded information summarizing the authorized driving status to the law-enforcement officer as an information aid to the law-enforcement officer in determining a course of action.

19. The method recited in claim 18 wherein:
the optically encoded information identifying the authorized holder comprises an optically encoded photograph of the authorized holder; and
generating the display comprises generating a rendering of the photograph for presentation to the law-enforcement officer.

20. The method recited in claim 18 wherein:
the optically encoded information identifying the authorized holder comprises a list of physical characteristics of the authorized holder; and
generating the display comprises preparing the list for presentation to the law-enforcement officer as text.

21. The method recited in claim 18 wherein:
the optically encoded information identifying the authorized holder comprises an optically encoded fingerprint of the authorized holder; and
generating the display comprises generating a rendering of the fingerprint for presentation to the law-enforcement officer.

22. The method recited in claim 18 wherein the authorized driving status comprises specification of a license classification of the authorized holder.

23. The method recited in claim 18 wherein the authorized driving status comprises specification of driving restrictions placed on the authorized holder.

24. The method recited in claim 18 wherein the authorized driving status comprises specification of a history of driving infractions assessed against the authorized holder.

25. The method recited in claim 18 wherein the optical motor-vehicle card further includes a registration-information field having optically encoded information identifying:
a vehicle registered with a vehicle-registration authority; and
an owner of the vehicle,
the method further comprising:
decoding, with the optical-card processing unit, the optically encoded information identifying the vehicle and the owner; and
displaying the decoded information identifying the vehicle and the owner to the law-enforcement officer as part of the information aid to the law-enforcement officer in determining a course of action.

26. The method recited in claim 18 wherein the optical motor-vehicle card further includes an insurance field having optically encoded information identifying driving insurance carried by the authorized holder, the method further comprising:
decoding, with the optical-card processing unit, the optically encoded information identifying the driving insurance; and
displaying the decoded information identifying the driving insurance to the law-enforcement officer as part of the information aid to the law-enforcement officer in determining a course of action.
